(19) United States
(12) Patent Application Publication
(10) Pub. No.: US 2002/0156960 A1
(43) Pub. Date: Oct. 24, 2002

(54) Computer system, and expansion board and connector used in the system

(75) Inventor: Yuichi Koga, Hachioji-shi (JP)

Correspondence Address: Finnegan, Henderson, Farabow,, Garrett & Dunner, L.L.P., 1300 I Street, N.W., Washington, DC, 20005-3315, US

(73) Assignee: KABUSHIKI KAISHA TOSHIBA

(21) Appl. No.: 10/092,490

(22) Filed: Mar. 8, 2002

(30) Foreign Application Priority Data
Mar. 30, 2001 (JP) 2001-100539

(51) Int. Cl. G06F 13/00

(52) U.S. Cl. 710/301

(57) ABSTRACT

A computer system according to the present invention includes a system board, a driver connected to the system board, which outputs data, a transmission line to transmit the data output from the driver, a receiver connected to the transmission line, which receives the data output from the driver, and an impedance matching element connected to the transmission line and having an impedance which is equal to a difference between an output impedance of the driver and an input impedance of the receiver.

### CROSS-REFERENCE TO RELATED APPLICATIONS

This application is based upon and claims the benefit of priority from the prior Japanese Patent Application No. 2001-100539, filed Mar. 30, 2001, the entire contents of which are incorporated herein by reference.

### BACKGROUND OF THE INVENTION

1. Field of the Invention

The present invention relates to a computer system and an expansion board and a connector both used in the system. More specifically, this invention relates to a computer system that increases the transmission speed of a transmission line of a printed wiring board and an expansion board and a connector both used in the system.

2. Description of the Related Art

In a prior art computer system, an expansion board is attached to a system board to extend the function of the system. A connector is provided on a transmission line of the system board, and the transmission line is connected to that of the expansion board through the connector.

A high-quality transmission line that causes no or little reflection is achieved on condition that the impedance of an output buffer, that of wiring, and that of an input buffer are all the same (this condition will be referred to as impedance matching condition hereinafter). In order to satisfy this condition, conventionally, a series terminal resistor was provided close to an output buffer and a parallel terminal resistor was provided close to an input buffer.

The terminal resistor is usually designed with the highest-load condition in mind. In an example of a computer system, generally, the highest-load condition means that an expansion board is mounted on each of a plurality of extension slots and the load on the expansion board is the highest.

However, when the system configuration does not provide the highest-load condition (generally when an expansion board is not mounted on at least one of a plurality of extension slots), the above impedance matching condition is not met; therefore, a high-quality transmission line cannot be achieved.

### BRIEF SUMMARY OF THE INVENTION

The present invention has been developed in consideration of the above situation and an object of the invention is to provide a computer system including a transmission line that always satisfies impedance matching conditions, and an expansion board and a connector both used in the computer system.

To attain the above object, according to a first aspect of the present invention, there is provided a computer system comprising a system board including a first connector and a second connector arranged in parallel with a first transmission line including at least one element a first board including a second transmission line which is connected to the first transmission line through the first connector and to which an element having an impedance is connected; and a second board including a third line which is connected to the first transmission line through the second connector and to which a dummy load.

In the present invention described above, the dummy load can be a capacitor.

Consequently, the invention comprises an impedance matching element. Since the impedance matching condition of the transmission line can be satisfied and thus a computer system including a high-quality transmission line can be provided.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a block diagram showing a computer system in which two expansion boards are attached to a system board.

FIG. 2 is a block diagram showing a computer system in which one expansion board is attached to a system board.

FIG. 3 is a block diagram showing a computer system including a dummy board according to an embodiment of the present invention.

FIGS. 4A and 4B are block diagrams showing expansion boards having different loads.

FIG. 5 is a block diagram showing an expansion board including a dummy load.

FIG. 6 is a block diagram showing a system board including a dummy load.

FIG. 7 is a block diagram showing a connector including a dummy load.

### DETAILED DESCRIPTION OF THE INVENTION

A computer system according to an embodiment of the present invention will now be described with reference to the accompanying drawings.

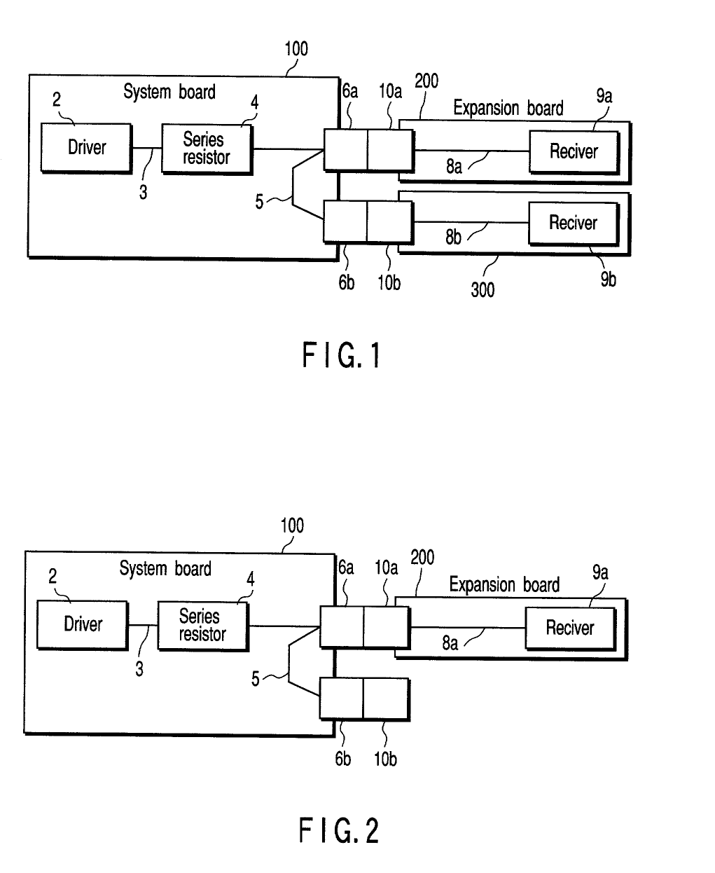

FIG. 1 is a block diagram showing a computer system in which two expansion boards are attached to a system board.

In FIG. 1, reference numeral 100 indicates a system board of the computer system. Expansion boards 200 and 300 are connected to the system board 100 through connectors 6a and 6b of the system bard 100 and connectors 10a and 10b of the expansion boards, respectively. The system board 100 is a printed circuit board.

A driver 2 for driving a transmission line 3, a series resistor 4 arranged close to the driver 2, and connectors 6a and 6b for connecting the system board 100 to the expansion boards 200 and 300 are mounted on the system board 100. The driver 2 and series resistor 4 are connected to each other by the transmission line 3, and the series resistor 4 and the connectors 6a and 6b are connected to each other by a transmission line 5.

As illustrated in FIG. 1, the connectors 6a and 6b are connected in parallel to the series resistor 4. Thus, even though an expansion board is not attached to one of the connectors, the computer system can be operated regardless of the quality of the transmission line.

Considering that a module is added to the transmission line, its similar technique is Rambus. Memory modules are connected in line with the Rambus. If even one of the memory modules is detached from the Rambus, the Rambus cannot be operated. To prevent this, a dummy RAM module is inserted in the Rambus to secure the operation of the Rambus.

In the computer system of the present embodiment, however, the expansion boards are connected to the transmission lines not in series but in parallel to each other. Thus, the whole system can be operated even though one of the expansion boards is detached from the transmission line. In this respect, the present invention differs from the Rambus technique. The present invention aims at improving the quality of the transmission lines and thus differs from the Rambus technique that aims at securing its operation.

A connector 10a connected to the connector 6a of the system board 100 and a receiver 9a serving as an input of the transmission line are mounted on the expansion board 200. The connector 10a and receiver 9a are connected to each other by a transmission line 8a.

A connector 10b connected to the connector 6b of the system board 100 and a receiver 9b serving as an input of the transmission line are mounted on the expansion board 300. The connector 10b and receiver 9b are connected to each other by a transmission line 8b.

The following condition is generally met in order to achieve a high-quality transmission line:

Output Impedance of Driver=Line Impedance=Input Impedance of Receiver (1)

Considering the transmission line in the foregoing computer system, the receivers of the transmission lines exist on the expansion boards 200 and 300.

Assuming that the input impedances (Zr) of the receivers 9a and 9b are equal to each other, the total input impedance (Zr_total) is given by the following equation (2):

Zr_total=(Zr×Zr)/(Zr+Zr)=0.5★Zr (2)

Let us consider the output impedance. The computer system includes the driver 2 and the series resistor 4 arranged close to the driver 2. The sum of the output impedance (Zd) of the driver and the value (Rs) of the series resistor corresponds to the total output impedance (Zd_total) of the driver and is given by the following equation (3):

Zd_total=Zd+Rs (3)

Let us consider the impedance of the transmission line then.

In the computer system, the transmission lines (wires) 3 and 5 are included in the system board 100. The transmission lines 8a and 8b are included in the expansion boards 200 and 300, respectively. The transmission lines 8a and 8b have line impedances Z200 and Z300 that are equal to the input impedances Zr of the receivers 9a and 9b, respectively. The transmission lines 3 and 5 have transmission line impedance Z1 that is equal to the total input impedances Zr_total of the driver. These impedances are expressed by the following equations (4) and (5):

Z200=Z300=Zr (4)

Z100=Zr_total=0.5★Zr (5)

When a transmission line that satisfies the above equations (2), (3), (4) and (5) is achieved, the equation (1) is met and high-quality transmission can be attained accordingly. The above system is referred to as a system 1 for the sake of convenience.

The transfer lines of the above system from which the expansion board 300 is detached will now be described. The values Zr, Zd, Rs, Z100 and Z200 are the same as those of the system 1 described above.

Let us consider the input impedance. Unlike in the system 1, the number of receivers is only one and accordingly the input impedance (Zr_total2) is given by the following equation (6):

Zr_total2=Zr (6)

The output impedance (Zd_total2) and the line impedances (Z100_2, Z200_2) are the same as those of the system 1.

In other words, the output impedance is expressed by the equation (3) and the line impedance is expressed by the equations (4) and (5). Since the system 1 satisfies the equation (1), the output impedance (Zd_total2) and the line impedances (Z100_2, Z200_2) are given by the following equations (7) to (9):

Zd_total2=0.5★Zr (7)

Z100_2=0.5★Zr (8)

Z200_2=Zr (9)

Since it is apparent from the above that Zd_total2, Z1_2 and Zr_total2 are not equal to each other, the system does not satisfy the equation (1). Thus, the system does not allow high-quality transmission. This system is referred to as a system 2 for the sake of convenience.

The computer system according to the embodiment of the present invention satisfies the impedance matching condition of the transmission lines even when the expansion board is detached as illustrated in FIG. 2.

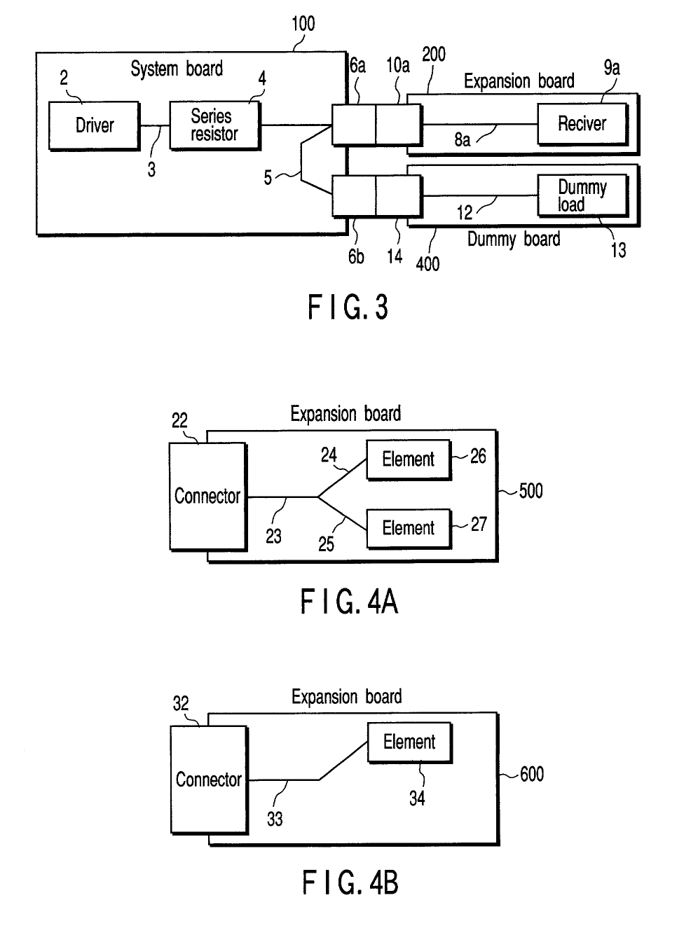

FIG. 3 is a block diagram showing a computer system according to the embodiment of the present invention, in which a dummy board is attached to a system board.

The values Zr, Zd, Rs, Z100 and Z200 of the computer system shown in FIG. 3 are the same as those of the system 1 described above.

A dummy board 400 of the computer system will now be described. The dummy board 400 is mounted with a transmission line 12 having an impedance that is equal to that of the transmission line 8a, a dummy load (impedance regulating element) 13 having an impedance that is equal to that of the receiver 9a, and a connector 14 for connecting the dummy board 400 to a connector of the system board 100.

The dummy load 13 and connector 14 are connected to each other by the transmission line 12. The connector 14 of the dummy board 400 and the connector 6b of the system board 100 are connected to each other and accordingly the transmission line 5 of the system board 100 and the transmission line 12 of the dummy board 400 are connected to each other.

In order to match the impedances of the dummy load 13 with that of the receiver 9a, the following technique is adopted in the embodiment of the present invention. When the level of the transmission line changes, that is, the voltage of the driver 2 changes from a low level to a high level or from a high level to a low level, it is a capacitance component that dominates the input impedance of the receiver 9a. The dummy load 13 is therefore mounted with a capacitor whose input capacitance is equal to that of the receiver 9a.

If the dummy board 400 having transmission line characteristics that are equal to those of the expansion board 200 is mounted on the system board 100, the total input impedance (Zr_total3) is given by the following equation (10):

Zr_total3=0.5★Zr (10)

Since the output impedance (Zd_total 3) and the line impedances (Z100_3, Z200_3, Z400_3) have characteristics that are equal to those of the system 1, they are expressed as follows:

Zd_total3=0.5★Zr (11)

Z100_3=0.5★Zr (12)

Z200_3=Z400_3=Zr (13)

Since the computer system of the present embodiment satisfies the equation (1) based on the equations (10) to (13), high-quality transmission can be performed. Since, moreover, the dummy load 13, namely only the capacitor is mounted on the dummy board 400, a high-quality transmission line that prevents its costs from increasing can be obtained. The above-described system is referred to as a system 3 for the sake of convenience.

According to the computer system of the present embodiment, even though an expansion board is detached, if a dummy board is attached instead, a high-quality transmission line can be achieved as in the case where the expansion board is attached.

### ANOTHER EMBODIMENT

In the computer system according to the foregoing embodiment, the load of the dummy board is the same as that of the expansion board, assuming that the loads of expansion boards attached to the system board are the same.

The present embodiment is directed to the use of expansion boards having different loads.

FIGS. 4A and 4B are block diagrams of expansion boards 500 and 600 having different loads.

Assume that the expansion board 500 includes two elements and the expansion board 600 includes one element.

A connector 22 for connecting the expansion board 500 to the system board and elements 26 and 27 serving as receivers are mounted on the expansion board 500. A transmission line 23 is connected to the connector 22, and the elements 26 and 27 are connected to their respective transmission lines 24 and 25 that branch off from a transmission line 23. In other words, the elements 26 and 27 are connected in parallel to the transmission line 23.

On the other hand, a connector 32 for connecting the expansion board 600 to the system board and an element 34 serving as a receiver are mounted on the expansion board 600. The connector 32 and element 34 are connected to each other by a transmission line 33.

In this embodiment, the input impedances of the elements 26, 27 and 34 serving as receivers are considered to be the same for the sake of convenience. The input impedance Tr500 of the expansion board 500 is given by the following equation (14):

Tr500=0.5★Tr (14)

The input impedance Tr600 of the expansion board 600 is given by the following equation (15):

Tr600=Tr (Tr is impedance of a single element) (15)

When the expansion board 500 or 600 may be connected to the system board mounted with a driver, the output impedance of the driver has to be changed in order to match the input impedance. If the output impedance of the driver is fixed and expansion boards having different input impedances may be mounted, the input impedance of the driver and output impedance of the expansion board do not match each other according to a combination of the expansion boards.

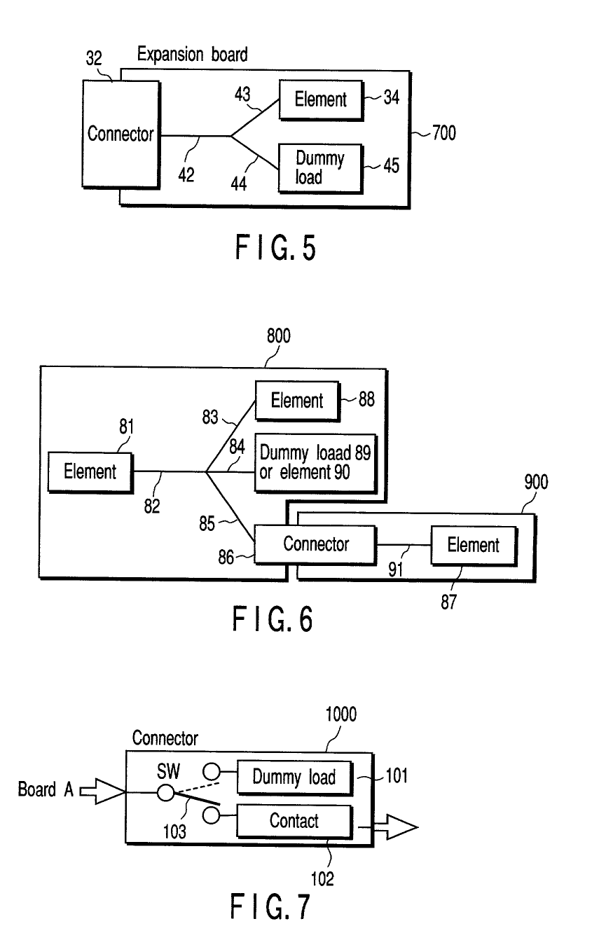

In the computer system according to the present embodiment, an expansion board 700 as shown in FIG. 5 is provided in place of the expansion board 600 when the loads of the elements mounted on the expansion boards are different.

As illustrated in FIG. 5, a connector 32 for connecting the expansion board to the system board, an element 34 and a dummy load 45 are mounted on the expansion board 700. A transmission line 42 is connected to the connector 32, and the element 34 and dummy load 45 are connected to their respective transmission lines 43 and 44 that branch off from the transmission line 42.

The impedance of the dummy load 45 is the same as that of the element 34. In other words, the elements 26 and 27 of the expansion board 500 and the element 34 and dummy load 45 of the expansion board 700 all have the same input impedance.

The line impedance of the transmission lines 23, 24 and 25 of the expansion board 500 and that of the transmission lines 42, 43 and 44 of the expansion board 700 are the same.

Thus, the input impedance of the expansion board 700 is expressed by the following equation (16):

Tr700=0.5★Tr (16)

The input impedance of the expansion board 700 becomes equal to that of the expansion board 500.

The above technique is effective in controlling a load on the system board.

FIG. 6 is a block diagram showing a system board to which a dummy load can be attached. Referring to FIG. 6, a connector 86 for connecting a system board 800 to an expansion board 900, elements 81 and 88, and a dummy load 89 or an element 90 are mounted on the system board 800.

The element 81 is a driver and its output impedance is set equal to the input impedance of each of the elements 88 and 90 on the system board and an element 87 on the expansion board 900.

The element 81 is connected to a transmission line 82. The element 88, dummy load 89 or element 90, and connector 86 are connected to their respective transmission lines 83, 84 and 85 which branch off from the transmission line 82. If the input impedance of the connector 86 is ignored, the impedance of the transmission lines 82 to 85 becomes equal to the input impedance of the elements 88 and 90.

The element 87 on the expansion board 900 is connected to the transmission line 85 through the connector 86 and the transmission line 91. The impedance of the transmission line 91 is set equal to the input impedance of the element 87.

If the element 90 is an extension module, it is mounted or not according to its product grade. In a prior art computer system, a transmission line (84) was opened when a memory module (element 90) was not mounted. The impedance matching condition was not satisfied and thus the quality of the transmission line was decreased.

In the computer system according to the present embodiment, the dummy load 89 having the same impedance as that of the element 90 is used in place of the element 90 and connected to the transmission line, with the result that the impedance matching condition is maintained and the quality of the transmission line is secured.

Consequently, in the present embodiment, the impedance matching condition can be satisfied and the quality of the transmission line can be secured by mounting the dummy load on the system board or the expansion board.

In the above-described embodiment, the dummy load is mounted on the system board or the expansion board. However, the present invention is not limited to this configuration.

FIG. 7 is a block diagram showing a connector including a dummy load.

Referring to FIG. 7, a connector 1000 connects boards A and B together. Assume that the board A is a system board of the computer system and the board B is an expansion board thereof.

A switch 103 is a mechanical switch. When the board B is attached to the connector 1000, the switch 103 is connected to a contact 102 to electrically connect the boards A and B with each other.

When the board B is not connected to the connector 1000, the switch 103 is connected to the dummy load 101 to electrically connect the board A with the dummy load 101. The dummy load 101 has the same impedance as that of the load of the board B, which satisfies the matching condition of the transmission line.

With such a connector, the impedance matching condition can be satisfied without using any dummy board and thus the high-quality transmission line can be provided.

The above embodiments can be combined as appropriately as possible. Advantages are obtained from respective combinations of the embodiments. Each of the embodiments contains inventions of various stages, and these inventions are extracted from appropriate combinations of a plurality of constituents disclosed. For example, when an invention extracted from the constituents of the embodiments from which some constituents are excluded is reduced to practice, the excluded constituents are appropriately compensated for common techniques.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A computer system comprising:
a system board including a first connector and a second connector arranged in parallel with a first transmission line including at least one element;
a first board including a second transmission line which is connected to the first transmission line through the first connector and to which an element having an impedance is connected; and
a second board including a third line which is connected to the first transmission line through the second connector and to which a dummy load.

2. The system according to claim 1,
wherein an impedance of the dummy load is equal to the impedance of the element.

3. The system according to claim 2,
wherein the dummy load is a capacitor.

4. A computer system comprising:
a system board including at least one element connected to a transmission line and a connector connected to the transmission line; and
an expansion board connected through the connector,
wherein an impedance matching element for impedance matching of the transmission line is connected to the transmission line of the system board when the expansion board is connected.

5. The computer system according to claim 4,
wherein the impedance matching element is a capacitor.

6. A connector to connect a transmission line of a system board with a transmission line of an expansion board together, the connector comprising:
an impedance matching element having an impedance which is equal to that of the expansion board; and
a mechanical switch which connects the transmission line of the system board to the impedance matching element when the expansion board is not attached to the connector.

7. The connector according to claim 6, wherein the impedance matching element is a capacitor.
